(19) United States
(12) Patent Application Publication
(10) Pub. No.: US 2009/0121632 A1
(43) Pub. Date: May 14, 2009

(54) Plasma display device and driving apparatus thereof

(76) Inventor: Sang-Young Lee, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 12/289,442

(22) Filed: Oct. 28, 2008

(30) Foreign Application Priority Data
Nov. 14, 2007 (KR) 10-2007-0116127

(51) Int. Cl. H01J 1/54

(52) U.S. Cl. 313/584

(57) ABSTRACT

A plasma display device and an apparatus for driving the same are provided. The plasma display device includes a first transistor connected between a plurality of first electrodes and a power source adapted to supply a high level voltage of a sustain pulse and a second transistor connected between a power source adapted to supply a low level voltage of a sustain pulse and the first electrodes. A first end of an inductor is connected to the first electrodes. Third and fourth transistors are connected between a second end of the inductor and a power recovery capacitor. Device characteristics of at least one of the first and second transistors are different from those of at least one of the third and fourth transistors.

### BACKGROUND OF THE INVENTION

1. Field of the Invention

Embodiments relate to a plasma display device and a driving apparatus thereof.

2. Description of the Related Art

A plasma display device uses a plasma display panel (PDP) that displays characters or images using plasma generated by gas discharge.

To drive a plasma display device, one frame is divided into a plurality of subfields having different luminance weights. Light emitting cells and non-emitting cells are selected during an address period of each subfield. During a sustain period of each subfield, in the light emitting cells, sustain discharge occurs a number of times corresponding to the luminance weight of the subfield.

In general, high and low level voltages are alternately applied to electrodes used for performing sustain discharge during each sustain period. The electrodes by which the sustain discharge occurs function as capacitive components. Thus, a reactive power is necessary to alternately apply the high and low level voltages to the electrodes. Therefore, a sustain discharge circuit of the plasma display device includes a switch for applying the high level voltage, a switch for applying the low level voltage, and an energy recovery circuit for recovering and reusing a reactive power.

The energy recovery circuit includes a switch for gradually increasing the voltage of the electrodes to near the high level voltage, a switch for gradually reducing the voltage of the electrodes to near the low level voltage, an inductor, and a capacitor. As described above, the sustain discharge circuit includes a plurality of switches having different functions. Generally, a switching loss and a conduction loss are incurred during switching operations of the switches. A kind of loss and/or a degree of loss vary in accordance with the function of the switch. Therefore, when elements having a same characteristic as each other are used for the switches having the different functions, power consumption may increase and discharge efficiency may be deteriorated.

The above information disclosed in this Background section is only for enhancement of understanding of the background of the invention and therefore it may contain information that does not form the prior art that is already known in this country to a person of ordinary skill in the art.

### SUMMARY OF THE INVENTION

Embodiments of the present invention are therefore directed to a plasma display device and an apparatus for driving a plasma display device, which substantially overcome one or more of the problems due to the limitations and disadvantages of the related art.

It is therefore a feature of an embodiment of the present invention to provide a plasma display device that is configured to reduce power consumption relative to conventional plasma display devices.

It is therefore a separate feature of an embodiment of the present invention to provide a plasma display device that is configured to increase discharge efficiency relative to conventional plasma display devices.

It is therefore a separate feature of an embodiment of the present invention to provide an apparatus for driving a plasma display device that is configured to reduce power consumption.

It is therefore a separate feature of an embodiment of the present invention to provide an apparatus for driving a plasma display device that is configured to increase discharge efficiency.

At least one of the above and other features and advantages of the present invention may be realized by providing a plasma display device, including an electrode, a first transistor connected between a first power source adapted to supply a first voltage and the electrode, a second transistor connected between a second power source adapted to supply a second voltage lower than the first voltage and the electrode, at least one inductor having a first end connected to the electrode, a third transistor connected between a third power source adapted to supply a voltage within a range between the first and second voltages and a second end of the inductor and forming a path for increasing a voltage of the electrode, and a fourth transistor connected between the third power source and the second end of the inductor and forming a path for reducing the voltage of the electrode, wherein device characteristics of the first and second transistors are different from those of the third and fourth transistors.

The first and the second transistors may be FETs (Field Effect Transistors), and the third and the fourth transistors may be IGBTs (Insulated Gate Bipolar Transistors).

The first transistor, the second transistor, the third transistor and the fourth transistor may all be n-channel transistors.

The first transistor, the second transistor, the third transistor and the fourth transistor may all be p-channel transistors.

The third power source may include a capacitor adapted to supply an intermediate voltage between the first and second voltages.

The device may further include a controller that turns on the third, first, fourth, and second switches in this order during the sustain period.

The first transistor and the second transistor may have a lower conduction loss than the third transistor and the fourth transistor. The third and the fourth transistor may have a lower switching loss than the first transistor and the second transistor.

The first transistor and the second transistor may have a lower conduction loss than the third transistor and the fourth transistor.

At least one of the above and other features and advantages of the present invention may be separately realized by providing an apparatus for driving a plasma display device including a plurality of first electrodes, including a first switch connected between a first power source adapted to supply a first voltage and the first electrodes, a second switch connected between a second power source adapted to supply a second voltage lower than the first voltage and the first electrodes, an inductor having a first end connected to the first electrodes, a capacitor connected to a second end of the inductor and adapted to charge a voltage within a range between the first and second voltages, a voltage increasing path including a third switch, the voltage increasing path adapted to increase a voltage of the first electrodes by connecting the capacitor to the inductor when the third switch is turned on, and a voltage decreasing path including a fourth switch, the voltage decreasing path adapted to decrease a voltage of the first electrodes by connecting the capacitor to the inductor when the fourth switch is turned on, wherein at least one of the first and second switches is of a first transistor type and at least one of the second and third switches is of a second transistor type, the first transistor type being different from the second transistor type.

The first transistor type may be an FET (Field Effect Transistor) and the second transistor type may be an IGBT (Insulated Gate Bipolar Transistor).

The plasma display device may further include a plurality of second electrodes for performing a sustain discharge together with the first electrodes, and the second voltage is applied to the second electrodes while the first voltage is applied to the first electrodes during the sustain period and the first voltage is applied to the second electrodes while the second voltage is applied to the first electrodes during the sustain period.

The plasma display device may further include a plurality of second electrodes for performing a sustain discharge together with the first electrodes, and the second electrodes are applied with a voltage within a range between the first and second voltages during the sustain period.

The first transistor type may have at least one of different conduction loss and switching loss characteristics than the second transistor type.

At least one of the above and other features and advantages of the present invention may be separately realized by providing a plasma display device, including an electrode, a first transistor connected between a first power source adapted to supply a first voltage and the electrode, a second transistor connected between a second power source adapted to supply a second voltage lower than the first voltage and the electrode, at least one inductor having a first end connected to the electrode, a third transistor connected between a third power source adapted to supply a voltage within a range between the first and second voltages and a second end of the inductor and forming a path for increasing a voltage of the electrode, and a fourth transistor connected between the third power source and the second end of the inductor and forming a path for reducing the voltage of the electrode, wherein at least one of the first transistor and the second transistor have at least one of different conduction loss and switching loss characteristics than at least one of the third and fourth transistors.

At least one the first and the second transistors may be FETs (Field Effect Transistors), and at least one of the third and the fourth transistors may be IGBTs (Insulated Gate Bipolar Transistors).

### BRIEF DESCRIPTION OF THE DRAWINGS

The above and other features and advantages will become more apparent to those of ordinary skill in the art by describing exemplary embodiments thereof with reference to the attached drawings, in which:

FIG. 1 illustrates a schematic diagram of a plasma display device according to an exemplary embodiment of the present invention;

FIG. 2 illustrates an exemplary driving waveform for driving electrodes of the plasma display device of FIG. 1 according to an exemplary embodiment of the present invention;

FIG. 3 illustrates a sustain discharge circuit according to an exemplary embodiment of the present invention;

FIG. 4 illustrates an exemplary timing diagram of signals employable for driving the sustain discharge circuit of FIG. 3;

FIG. 5A illustrates a graph of exemplary current and voltage characteristics of terminals of transistors Yr and Yf of the sustain discharge circuit of FIG. 3;

FIG. 5B illustrates a graph of exemplary current and voltage characteristics of terminals of transistors Ys and Yg of the sustain discharge circuit of FIG. 3;

FIG. 6A illustrates a table including luminance, power consumption, and discharge efficiency values of the sustain discharge circuit of FIG. 3;

FIG. 6B illustrates a table including luminance, power consumption, and discharge efficiency values of the sustain discharge circuit of FIG. 3, when all of the transistors of the sustain discharge circuit are IGBTs; and

FIG. 6C illustrates a table including luminance, power consumption, and discharge efficiency of the sustain discharge circuit of FIG. 3, when all of the transistors of the sustain discharge circuit are FETs.

### DETAILED DESCRIPTION OF THE INVENTION

Korean Patent Application No. 10-2007-0116127, filed on Nov. 14, 2007, in the Korean Intellectual Property Office, and entitled: “Plasma Display Device and Driving Apparatus Thereof,” is incorporated by reference herein in its entirety.

Embodiments of the present invention will now be described more fully hereinafter with reference to the accompanying drawings, in which exemplary embodiments of the invention are illustrated. The drawings and description are to be regarded as illustrative in nature and not restrictive. More particularly, aspects of the invention may, however, be embodied in different forms and should not be construed as limited to the embodiments set forth herein. Rather, these embodiments are provided so that this disclosure will be thorough and complete, and will fully convey the scope of the invention to those skilled in the art.

It will also be understood that when an element is referred to as being “connected” to another element, it can be the directly or indirectly connected to the other element. Like reference numerals refer to like elements throughout the specification.

As used herein, the expressions “at least one,” and “and/or” are open-ended expressions that are both conjunctive and disjunctive in operation. For example, each of the expressions “at least one of A, B, and C,” “at least one of A, B, or C,” and “A, B, and/or C” includes the following meanings: A alone; B alone; C alone; both A and B together; both A and C together; both B and C together; and all three of A, B, and C together. Further, these expressions are open-ended, unless expressly designated to the contrary by their combination with the term “consisting of.” For example, the expression “at least one of A, B, and C” may also include an nth member, where n is greater than 3, whereas the expression “at least one selected from the group consisting of A, B, and C” does not.

Throughout the specification, maintaining the voltage means that, even when a potential difference between two specific points varies over time, the variation is within a range allowable in the design or the variation is caused by a parasitic component ignored in the design practice of the person skilled in the art. Further, since a threshold voltage of a semiconductor device (e.g., a transistor, a diode, etc.) may be very low as compared with a discharge voltage, the threshold voltage may be regarded as 0V and approximately processed. Therefore, voltages applied from a power source to a node(s), an electrode(s), etc., include voltages that are varied by the threshold voltage and the parasitic component.

An exemplary plasma display device and an exemplary apparatus employable for driving such a plasma display device according to one or more aspects of the invention will be described in detail below.

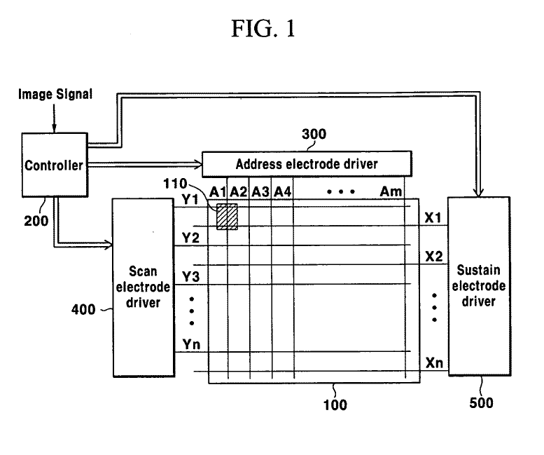

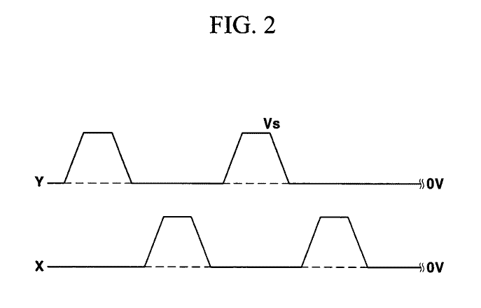

FIG. 1 illustrates a schematic diagram of a plasma display device according to an exemplary embodiment of the present invention. FIG. 2 illustrates an exemplary driving waveform for driving electrodes of the exemplary plasma display device of FIG. 1 according to an exemplary embodiment of the present invention. More particularly, for simplicity, FIG. 2 illustrates the exemplary driving waveform for driving, during a sustain period, one X-electrode and one Y-electrode of the plasma display device of FIG. 1.

As shown in FIG. 1, a plasma display device according to an exemplary embodiment of the present invention may include a plasma display panel (PDP) 100, a controller 200, an address electrode driver 300, a scan electrode driver 400, and a sustain electrode driver 500.

The PDP may include a plurality of address electrodes (hereinafter, referred to as “A-electrodes”) A1-Am extending in a column direction, a plurality of sustain electrodes (hereinafter, referred to as “X-electrodes”) X1-Xn, and a plurality of scan electrodes (hereinafter, referred to as “Y-electrodes”) Y1-Yn. Generally, the X-electrodes X1-Xn may be arranged corresponding to the Y-electrodes Y1-Yn, e.g., alternately, so that corresponding ones of the X-electrodes X1-Xn and the Y-electrodes Y1-Yn may perform a display operation for displaying an image during a sustain period. The Y-electrodes Y1-Yn and the X-electrodes X1-Xn may be arranged perpendicular to the A-electrodes A1-Am. Overlapping regions of the A-electrodes A1-Am and the X and Y-electrodes X1-Xn and Y1-Yn may define discharge cells 110. The above-described structure of the exemplary PDP is provided as an example. That is, aspects of the invention may be embodied in PDPs having structures other than those described above to which a driving waveform that will be described below may be applied.

Referring to FIG. 1, the controller 200 may receive externally supplied image signals and may output A-electrode driving signals, X-electrode driving signals, and Y-electrode driving signals. The controller 200 may divide one frame into a plurality of subfields and may drive the subfields.

The address electrode driver 300 may apply a driving voltage to the A-electrodes A1-Am in accordance with the A-electrode driving control signals from the controller 200.

The scan electrode driver 400 may apply a driving voltage to the Y-electrodes Y1-Yn in accordance with the Y-electrode driving control signals from the controller 200.

The sustain electrode driver 500 may apply a driving voltage to the X-electrodes X1-Xn in accordance with the X-electrode driving control signals from the controller 200.

More particularly, the address, scan and sustain electrode drivers 300, 400, and 500 may select discharge cells that will be turned on or off in the corresponding subfields among the discharge cells 110 during the address period of each subfield.

As shown in FIG. 2, during the sustain period of each subfield, the scan electrode driver 400 may apply to the Y-electrodes Y1-Yn sustain pulses, which alternately have high and low level voltages (Vs and 0V). The sustain electrode driver 500 may apply to the X-electrodes X1-Xn sustain pulses, which are opposite in phase to the sustain pulses applied to the Y-electrodes Y1-Yn. The X1-Xn sustain pulses and the Y1-Yn sustain pulses may be applied a number of times corresponding to a weight of the corresponding subfields. By doing as described above, a voltage difference between each of the Y-electrodes and each of the X-electrodes may alternate between a Vs voltage and −Vs voltage. Thus, the sustain discharge may repeatedly occur, a predetermined number of times, in the discharge cells to be turned on.

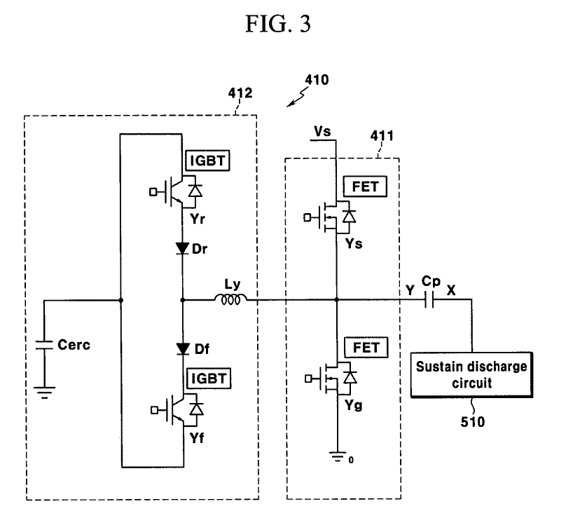

An exemplary sustain discharge circuit 410 for applying the sustain pulses of FIG. 2 will be described with reference to FIG. 3.

FIG. 3 illustrates the sustain discharge circuit 410 according to an exemplary embodiment of the present invention. The sustain discharge circuit 410 may be commonly connected to the Y-electrodes Y1-Yn. In addition, a sustain discharge circuit 510 may be commonly connected to the X-electrodes X1-Xn. The sustain discharge circuit 510 may be the same as the sustain discharge circuit 410. For simplicity, in FIG. 3, only one X-electrode and only one Y-electrode are illustrated. In FIG. 3, the reference character Cp indicates a capacitive component formed by the X and Y-electrodes.

As shown in FIG. 3, the sustain discharge circuit 410 may include a sustain discharge unit 411 and an energy recovery unit 412. The sustain discharge unit 411 may include transistors Ys and Yg. The energy recovery unit 412 may include transistors Yr and Yf, an inductor (Ly), and diodes Dr and Df. In the exemplary embodiment illustrated in FIG. 3, the transistors Ys and Yg are field effect transistors (FETS) and the transistors Yr and Yf are insulated gate bipolar transistors (IGBTs). In the transistors Ys and Yg, body diodes may be formed in a direction from a source to a drain thereof. In the transistors Yr and Yf, body diodes may be formed in a direction from an emitter to a collector thereof. In the exemplary embodiment illustrated in FIG. 3, all the transistors Ys, Yg, Yr, and Yf are n-channel types. However, embodiments of the invention are not limited thereto. For example, in some embodiments, the transistors Ys, Yg, Yr, and Yf may be p-channel types.

The drain and source of the transistor Ys may be respectively connected to a power source Vs supplying the high level voltage Vs and the Y-electrodes. The drain and source of the transistor Yg may be respectively connected to a power source, e.g., a ground terminal, supplying the low level voltage 0V and the Y-electrodes. A first end of the inductor Ly may be connected to the Y-electrodes and a second end of the inductor Ly may be connected to a cathode of the diode Dr and an anode of the diode Df. An emitter of the transistor Yr may be connected to an anode of the diode Dr and a collector of the transistor Yf may be connected to a cathode of the diode Df. A collector of the transistor Yr and an emitter of the transistor Yf may be connected to a capacitor Cerc that is an energy recovery power source. The capacitor Cerc may apply a voltage within a range from the high level voltage Vs to the low level voltage 0V, e.g., an intermediate voltage (Vs/2) between the voltages Vs and 0V. The diode Dr may form a current path for increasing the voltage of the Y-electrodes. The diode Df may form a current path for reducing the voltage of the Y-electrodes. In some embodiments, locations of the diode Dr and the transistor Yr may be exchanged and/or locations of the diode Df and the transistor Yf may be exchanged.

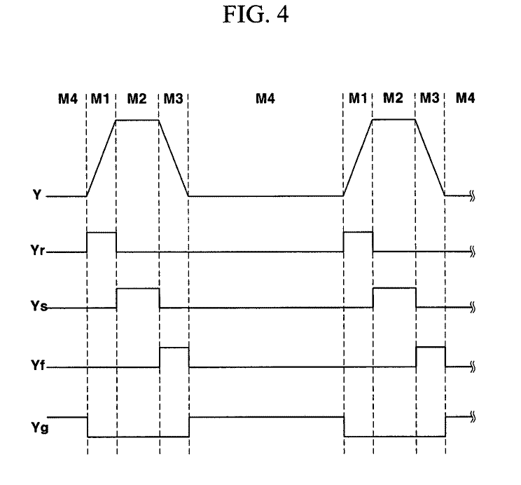

An exemplary operation of the sustain discharge circuit of FIG. 3 will be described below with reference to FIG. 4. FIG. 4 illustrates an exemplary timing diagram of signals employable for driving the sustain discharge circuit 410 of FIG. 3 In FIG. 4, it is assumed that the low level voltage, e.g., 0V, is applied to the Y-electrodes as the transistor Yg is turned on just before a first mode (M1) starts.

Referring to FIG. 4, during the first mode (M1), the transistor Yr may be turned on and the transistor Yg may be turned off. Then, resonance may be generated through a path through the capacitor Cerc, transistor Yr, diode Dr, inductor Ly, and panel capacitor Cp. Thus, the voltage of the Y-electrodes may increase.

Next, during a second mode (M2), the transistor Ys may be turned on and the transistor Yr may be turned off. Then, the high level voltage Vs may be applied to the Y-electrodes.

During a third mode (M3), the transistor Yf may be turned on and the transistor Ys may be turned off. Then, the voltage of the Y-electrodes may decrease by resonance generated through a path formed by the panel capacitor Cp, inductor Ly, diode Df, transistor Yf, and capacitor Cerc.

Next, during a fourth mode (M4), the transistor Yg may be turned on and the transistor Yf may be turned off. Thus, the low level voltage, e.g., 0V, may again be applied to the Y-electrodes.

The sustain discharge circuit 410 may repeat the first to fourth modes (M1-M4) a number of times corresponding to the weight of the corresponding subfield. Thus, the high and low level voltages Vs and 0V may be alternately applied.

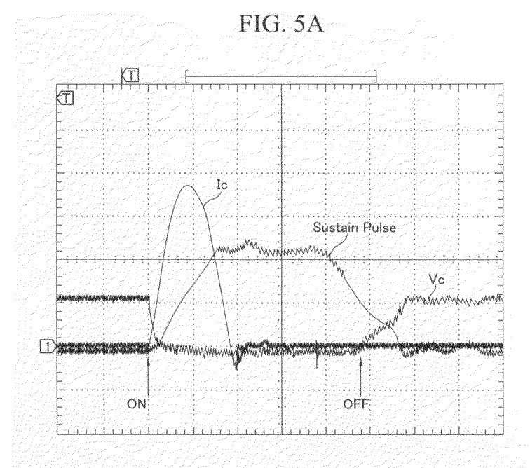

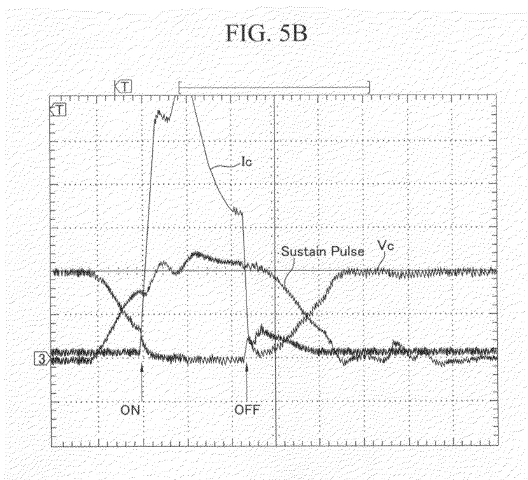

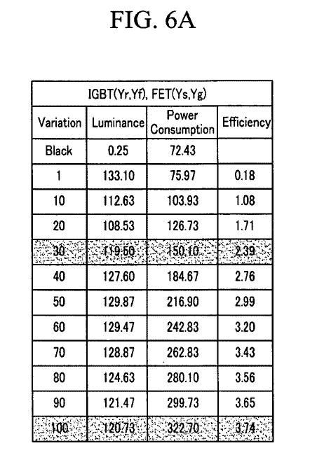

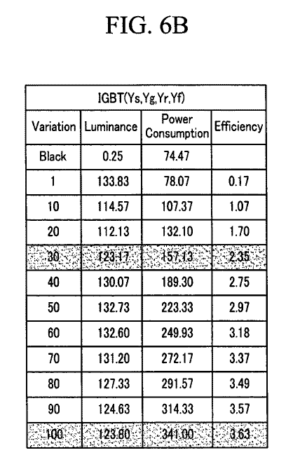

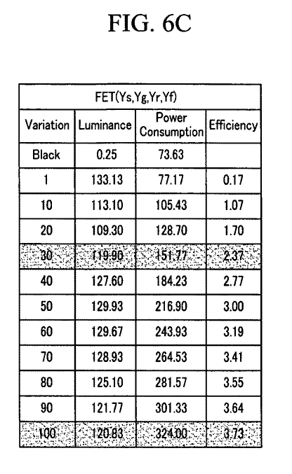

As described above, in embodiments of the invention, the transistors Ys, Yg, Yr, Yf may be of different transistor types. That is, e.g., while all the transistors Ys, Yg, Yr, Yf may be p-channel type or all the transistor Ys, Yg, Yr, Yf may be n-channel type, the transistors may be of different transistor types, e.g., FETs, IGBTs, etc. For example, in some embodiments the transistors Ys and Yg of the exemplary sustain discharge circuit 410 of FIG. 3 may be embodied as FETs and the transistors Yr and Yf of the exemplary sustain discharge circuit 410 of FIG. 3 may be embodied as IGBTs, while all of the transistors Ys, Yg, Yr, Yf are of n-channel type or all are of p-channel type. Some exemplary reasons for employing different transistor types for one or more of the transistors Yr, Yf, Ys, Yg in some embodiments of the sustain discharge circuit 410 will be described below with reference to FIGS. 5A, 5B, and 6A to 6C.

FIG. 5A illustrates a graph of exemplary current and voltage characteristics of terminals of transistors Yr and Yf of the sustain discharge circuit 410 of FIG. 3.

FIG. 5B illustrates a graph of exemplary current and voltage characteristics of terminals of transistors Ys and Yg of the sustain discharge circuit 410 of FIG. 3.

FIG. 6A illustrates a table including luminance, power consumption, and discharge efficiency values of the sustain discharge circuit 410 of FIG. 3. FIG. 6B illustrates a table including luminance, power consumption, and discharge efficiency values of the sustain discharge circuit 410 of FIG. 3, when all of the transistors of the sustain discharge circuit are IGBTs. FIG. 6C illustrates a table including luminance, power consumption, and discharge efficiency of the sustain discharge circuit 410 of FIG. 3, when all of the transistors of the sustain discharge circuit are FETs.

In FIG. 5A and FIG. 5B, the high level voltage Vs is 205V, and the respective transistors are IGBTs. In FIGS. 6A to 6C, the high level voltage Vs is 205V, and 127 pairs of sustain pulses are applied.

Generally, there may be power dissipation in a switch such as a transistor. Power dissipation may be represented as a sum of a switching loss and a conduction loss.

First, as shown in FIG. 5A, the transistors Yr and Yf experience power dissipation at a point when they are turned on due to a driving characteristic of the energy recovery circuit 412. However, the transistors Yr and Yf experience little or no power dissipation at a point when they are turned off. On the other hand, as shown in FIG. 5B, the transistors Ys and Yg experience power dissipation at a point when they are turned on and off.

Embodiments of the sustain discharge circuit 410 employing one or more aspects of the invention may employ transistors as switches having predetermined characteristics, e.g., transistor characteristics, that may reduce power dissipation of the sustain discharge circuit 410. For example, different types of transistors may be employed for the switches of the sustain discharge circuit 410 based on operation characteristics of respective nodes of the sustain discharge circuit 410.

More particularly, e.g., as discussed above with regard to FIGS. 5A and 5B, because transistors Yr and Yf may experience relatively little or no power dissipation at a point when they are turned off, switches having a characteristic that may reduce conduction loss rather than switching loss may be used as the transistors Yr and Yf. Further, as the transistors Ys and Yg may experience power dissipation at a point where they are turned off and on, switches having a characteristic that may reduce the switching loss may be used as the transistors Ys and Yg.

An IGBT is generally a current driving type having current tailing characteristics during a switching operation thereof. In an IGBT, the switching loss may account for about 70% of the power dissipation due to current tailing characteristics. On the other hand, in a FET, conduction loss may account for about 75% due to an Rds(on) characteristic during conduction thereof. Here, the Rds(on) means a resistance component generated by a channel during conduction. Therefore, in some embodiments, IGBTs may be used as the transistors Yr and Yf in order to reduce the conduction loss. FETs may be used as the transistors Ys and Yg to reduce the switching loss. In FIGS. 5A and 5B, reference character Ic indicates a current flow when the IGBT is conducted and reference character Vc indicates a voltage applied to opposite ends of the IGBT when the IGBT is conducted.

As may be noted from FIGS. 6A to 6C, aspects of the invention embodied in the exemplary sustain discharge circuit 410 may enable power consumption to be reduced and discharge efficiency to be increased as compared with a case where all of the transistors Ys, Yg, Yr, and Yf are formed of a same transistor type, e.g., Ys, Yg, Yr and Yf are all IGBTs and/or Ys, Yg, Yr and Yf are all FETs.

The above description of exemplary embodiments describes a case where sustain pulses having alternate high and low voltages Vs and 0V are applied to the X and Y-electrodes with opposite phases. However, embodiments of the present invention are not limited thereto. For example, in some embodiments, the sustain pulses may be applied to one of the X and Y-electrodes. That is, during the sustain period, sustain pulses that alternate between Vs and −Vs voltages may be applied to one of the X and Y-electrodes and a low level voltage 0V may be applied to the other of the X and Y-electrodes. In such embodiments, a voltage difference between the Y and X-electrodes becomes alternately the Vs and −Vs voltages, like the sustain pulses of FIG. 2. A sustain discharge circuit for generating such sustain pulses may have a structure similar to the sustain discharge circuit 410 of FIG. 3. For example, in the sustain discharge circuit 410 of FIG. 3, when the capacitor Cerc is removed and the source of the transistor Yg is connected to the power source for supplying −Vs voltage, sustain pulses that alternate between the Vs and −Vs voltages may be applied to the Y-electrodes.

In embodiments of the invention, by employing switches according to their functions and characteristics in a sustain discharge circuit, sustain discharge efficiency may be increased and/or power consumption may be reduced.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A plasma display device, comprising:
an electrode;
a first transistor connected between a first power source adapted to supply a first voltage and the electrode;
a second transistor connected between a second power source adapted to supply a second voltage lower than the first voltage and the electrode;
at least one inductor having a first end connected to the electrode;
a third transistor connected between a third power source adapted to supply a voltage within a range between the first and second voltages and a second end of the inductor, forming a path for increasing a voltage of the electrode; and
a fourth transistor connected between the third power source and the second end of the inductor, forming a path for reducing the voltage of the electrode, wherein device characteristics of the first and second transistors are different from those of the third and fourth transistors.

2. The plasma display device as claimed in claim 1, wherein the first and the second transistors are FETs (Field Effect Transistors), and the third and the fourth transistors are IGBTs (Insulated Gate Bipolar Transistors).

3. The plasma display device as claimed in claim 2, wherein the first transistor, the second transistor, the third transistor and the fourth transistor are all n-channel transistors.

4. The plasma display device as claimed in claim 2, wherein the first transistor, the second transistor, the third transistor and the fourth transistor are all p-channel transistors.

5. The plasma display device as claimed in claim 1, wherein the third power source includes a capacitor adapted to supply an intermediate voltage between the first and second voltages.

6. The plasma display device as claimed in claim 1, further comprising a controller that turns on the third, first, fourth, and second switches in this order during the sustain period.

7. The plasma display device as claimed in claim 1, wherein the first transistor and the second transistor have a lower conduction loss than the third transistor and the fourth transistor.

8. The plasma display device as claimed in claim 1, wherein the third and the fourth transistor have a lower switching loss than the first transistor and the second transistor.

9. The plasma display device as claimed in claim 8, wherein the first transistor and the second transistor have a lower conduction loss than the third transistor and the fourth transistor.

10. An apparatus for driving a plasma display device including a plurality of first electrodes, the apparatus comprising:
a first switch connected between a first power source adapted to supply a first voltage and the first electrodes;
a second switch connected between a second power source adapted to supply a second voltage lower than the first voltage and the first electrodes;
an inductor having a first end connected to the first electrodes;
a capacitor connected to a second end of the inductor and adapted to charge a voltage within a range between the first and second voltages;
a voltage increasing path including a third switch, the voltage increasing path adapted to increase a voltage of the first electrodes by connecting the capacitor to the inductor when the third switch is turned on; and
a voltage decreasing path including a fourth switch, the voltage decreasing path adapted to decrease a voltage of the first electrodes by connecting the capacitor to the inductor when the fourth switch is turned on,
wherein at least one of the first and second switches is of a first transistor type and at least one of the second and third switches is of a second transistor type, the first transistor type being different from the second transistor type.

11. The apparatus as claimed in claim 10, wherein the first transistor type is an FET (Field Effect Transistor) and the second transistor type is an IGBT (Insulated Gate Bipolar Transistor).

12. The apparatus as claimed in claim 10, wherein the first transistor, the second transistor, the third transistor and the fourth transistor are all n-channel transistors.

13. The apparatus as claimed in claim 10, wherein the first transistor, the second transistor, the third transistor and the fourth transistor are all p-channel transistors.

14. The apparatus as claimed in claim 10, wherein:
the plasma display device further includes a plurality of second electrodes for performing a sustain discharge together with the first electrodes; and
the second voltage is applied to the second electrodes while the first voltage is applied to the first electrodes during the sustain period and the first voltage is applied to the second electrodes while the second voltage is applied to the first electrodes during the sustain period.

15. The apparatus as claimed in claim 10, wherein:
the plasma display device further includes a plurality of second electrodes for performing a sustain discharge together with the first electrodes; and
the second electrodes are applied with a voltage within a range between the first and second voltages during the sustain period.

16. The apparatus as claimed in claim 10, wherein the first transistor type has at least one of different conduction loss and switching loss characteristics than the second transistor type.

17. A plasma display device, comprising:
an electrode;
a first transistor connected between a first power source adapted to supply a first voltage and the electrode;
a second transistor connected between a second power source adapted to supply a second voltage lower than the first voltage and the electrode;
at least one inductor having a first end connected to the electrode;
a third transistor connected between a third power source adapted to supply a voltage within a range between the first and second voltages and a second end of the inductor, forming a path for increasing a voltage of the electrode; and
a fourth transistor connected between the third power source and the second end of the inductor, forming a path for reducing the voltage of the electrode,
wherein at least one of the first transistor and the second transistor have at least one of different conduction loss and switching loss characteristics than at least one of the third and fourth transistors.

18. The plasma display device as claimed in claim 17, wherein at least one the first and the second transistors are FETs (Field Effect Transistors), and at least one of the third and the fourth transistors are IGBTs (Insulated Gate Bipolar Transistors).

19. The plasma display device as claimed in claim 17, wherein the first transistor, the second transistor, the third transistor and the fourth transistor are all n-channel transistors.

20. The plasma display device as claimed in claim 17, wherein the first transistor, the second transistor, the third transistor and the fourth transistor are all p-channel transistors.
